(19) United States
(12) Patent Application Publication
(10) Pub. No.: US 2003/0066087 A1
(43) Pub. Date: Apr. 3, 2003

(54) Digital transmission system having modulators remotely located from central media access control layer

(76) Inventors: Wilson E. Sawyer, East Hampstead, NH (US); John M. Ulm, Pepperell, MA (US); David Gingold, Somerville, MA (US); Jerald Archambault, Richfield Springs, NY (US)

Correspondence Address: ARRIS International, Inc., 11450 Technology Circle, Duluth, GA, 30097, US

(21) Appl. No.: 10/259,003

(22) Filed: Sep. 27, 2002

Related U.S. Application Data
(60) Provisional application No. 60/325,509, filed on Sep. 28, 2001.

(51) Int. Cl. H04N 7/173

(52) U.S. Cl. 725/111; 725/105; 725/129

(57) ABSTRACT

A hybrid distributed cable modem termination systems having mini fiber nodes containing CMTS modulators remotely located from the head end. DOCSIS MAC layer components are located at the head end. This lowers cost and allows use of a smaller mFN enclosure. The mFN has A/D converters for DOCSIS upstream traffic and for legacy upstream traffic. A multiplexer using forward error correction combines the legacy and DOCSIS traffic for upstream transmission along a single fiber at rates of approximately 2 Gbps. A splitter at the head end routes legacy traffic to legacy equipment and the DOCSIS traffic to the MAC layer components. A single power supply at the head end can be used to power the mFNs.

### CROSS REFERENCE TO RELATED APPLICATION

This application claims the benefit of priority under 35 U.S.C. 119(e) to the filing date of Ulm, U.S. provisional patent application No. 60/325,509 entitled “Digital Transmission System With Remote Modulators”, which was filed Sep. 28, 2001, and is incorporated herein by reference.

### FIELD OF THE INVENTION

This invention relates, generally, to communication networks and, more particularly, a system having mini fiber nodes (“mFN”), which may comprise modulators that are remotely located with respect to a centralized Media Access Control (“MAC”) layer.

### BACKGROUND

Current community antennae television (“CATV”) networks provide adequate bandwidth for downstream analog broadcast and even narrowcast video signals from a head end of central office to a plurality of subscribers. CATV networks are also used for downstream digital data transmission where subscribers use, for example, cable modems for Internet access. In addition to downstream transmission of signals, CATV networks may also be used for upstream transport of signals when cable modems are used for Internet access. As with downstream transmission, CATV networks may provide adequate upstream bandwidth for typical residential users who browse the Internet because the downstream traffic for such use typically comprises larger amounts of information than upstream traffic.

Although adequate upstream bandwidth may exist for typical Internet browsing, demand for greater upstream bandwidth is growing as the use of certain technologies that require large amounts of upstream bandwidth, such as, for example, video conferencing, increases. In addition, the demand for narrowcasting (directing signals to a specific subscriber or small group of subscribers) is also on the rise. To reduce the impact of physical infrastructure on bandwidth limitations, operators are evolving their HFC architectures such that fiber is being driven deeper into networks; in other words, closer to end users, such as residential customers or places of business. Thus, to take advantage of the greater bandwidth capabilities of the higher fiber densities in the evolving network architectures, network operators favor replacing current transmission technologies with technologies that facilitate digital transmission, both upstream and downstream, of high-bandwidth-using signals over fiber networks, as digital transmission is more robust, allows higher potential bandwidths and reduces product manufacturing and maintenance costs.

An example of such a digital transmission technology is the Data Over Cable Service Interface Specification (“DOCSIS”). In a typical DOCSIS compatible cable modem termination system (“CMTS”) having digital video system capability, the CMTS and/or video broadcast equipment is located at the head end. DOCSIS CMTS and digital video systems typically use modulators and demodulators at the head end to translate signals, such as, for example, Motion Picture Experts Group (“MPEG”) stream signals, between digital and analog format, and place them into a channel, typically using quadrature amplitude modulation (“QAM”), for transport over a hybrid fiber coax (“HFC”) system.

In order to better transmit digital signals over the fiber portion of an HFC, including facilitating the digitizing and upstream transporting of DOCSIS signals, it has been suggested that components for implementing CMTS functionality be located in mini fiber nodes (“mFN”). This approach is often referred to as distributed CMTS (“dCMTS”). However, despite any advantage of such an architecture, there are drawbacks to placing all of the CMTS components at an mFN. The physical size and power requirements of currently available integrated circuits may exceed the size and capabilities of a typical mFN.

Furthermore, upstream legacy support typically uses dedicated components, which increases the use of available physical space and cooling thereof. As used here, “legacy” refers to non-DOCSIS services that use upstream bandwidth (from the subscriber toward the head-end) on a network. These legacy uses typically relate to cable television set-top-box control, circuit-switched telephony-over-cable and pre-DOCSIS cable modems. In general, these signals are not demodulated at the mFN because they use a variety of proprietary modulation techniques.

Moreover, the active components that facilitate a CMTS system tend to malfunction over time, thereby incurring additional maintenance costs at the nodes that are typically remotely located with respect to the central office or head end.

Thus, there is a need for a network architecture that facilitates digital to analog conversion of downstream data signals at an mFN rather than at a head end to take advantage of the bandwidth potential of the fiber portion of a network and to provide narrowcast functionality. Furthermore, there is a need for digitizing upstream signals at the same mFN, thereby taking advantage of upstream fiber links to provide greater upstream transfer rates than are available with coax. In addition, there is a need for upstream-transport-support of analog legacy signals over a digital upstream link. Moreover, there is a need for a network architecture that minimizes manufacturing and maintenance costs.

### SUMMARY

It is an object to provide a modified dCMTS network architecture having modulators and demodulators at one of a plurality of mFN while relatively large MAC layer circuitry and other CMTS hardware components are centrally located at a head end. Thus, maximum advantage of the fiber portion's bandwidth can be taken while not exceeding the physical boundaries of the mFN enclosure.

It is also an object to use the mFN architecture to facilitate narrowcast digital video programming.

It is also an object to facilitate the remote relationship of the modulators with respect to the MAC components while still supporting legacy upstream transmission through the use of digital signal processing (“DSP”) means.

It is yet another object to provide upstream transport of analog legacy signals over a digital upstream link.

It is yet another object to provide hardware that reduces the costs, with respect to a distributed CMTS, of providing legacy support while utilizing the full bandwidth of a fiber uplink portion of an HFC network.

### BRIEF DESCRIPTION OF DRAWINGS

FIG. 1 illustrates a topological schematic of the fiber portion of an HFC using mFN technology and current dCMTS technology.

FIG. 2 illustrates a block diagram of the hardware components in an mFN as would be implemented using current dCMTS technology rather than centralized CMTS with remote modulator technology.

FIG. 3 illustrates a topological schematic of the fiber portion of an HFC using mFN technology in a centralized CMTS with remote modulator network architecture.

FIG. 4 illustrates a block diagram of the hardware components in an mFN used in a modified dCMTS network architecture.

FIG. 5 illustrates a hybrid CMTS system having centrally located MAC layer components at a head end and modulators located remotely from the head end in a mFN.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof. Furthermore, while some aspects of the present invention are described in detail herein, no specific fiber type, integrated circuit, laser, connector, enclosure, power supply or circuit board arrangement, for example, is required to be used in the practicing of the present invention. Indeed, selection of such parts and components would be within the routine functions of a designer skilled in the art.

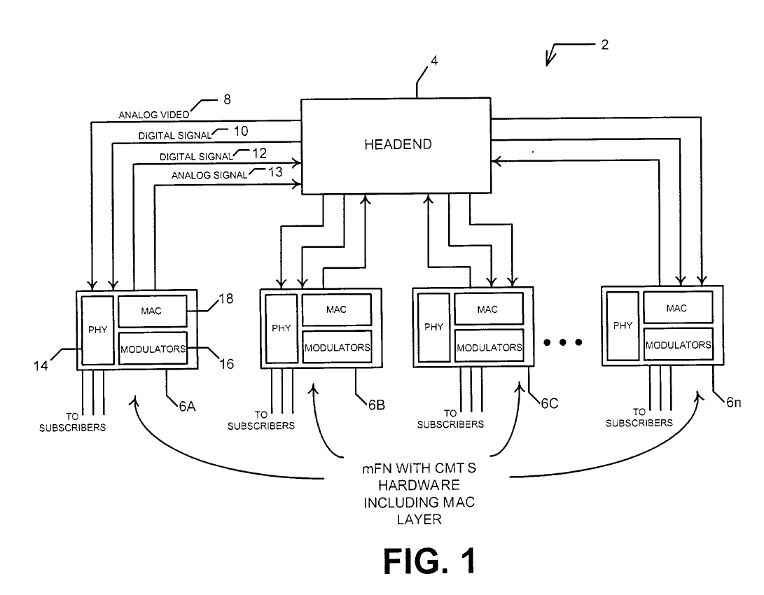

Turning now to the figures, FIG. 1 illustrates a topological schematic of the fiber portion of an HFC network 2 using conventional mFN and dCMTS technology. Such a system comprises a head end 4 that is in communication with a plurality of mFN units 6, each of which is further in communication with a plurality of subscribers. The signals communicated between the head end 4 and the mFN 6 may include downstream analog video signals 8, downstream digital data signals 10 and upstream digital data signals 12. The head end 4 delivers analog signals 8, such as, for example, CATV programming, as well as digital signals 10, such as for example, DOCSIS Internet, to the plurality of mFN 6. The analog signal 8 is typically passed through the mFN 6 to the subscriber's premise equipment (“SPE”), such as, for example, a network interface unit that distributes signals to a plurality of devices inside a home or office, including, but not limited to, an analog television, a personal computer, a digital telephone, a digital television, etc. The digital signal 10 is typically received at the mFN 6 and translated by CMTS hardware within the mFN for transmission to a SPE. The hardware within the mFN 6 may translate the incoming downstream digital signal 10 based on the DOCSIS standard, for example, for transmission to a DOCSIS-based SPE.

To effect such a translation, an mFN 6 typically includes, in addition to standard components such as a power supply for example, a physical layer (“PHY”) 14 and CMTS components. The CMTS components typically further include modulators 16 and a MAC layer components 18, the functions of which are known in the art, as are the physical interface components 14 (electrical to optical and vice versa, for example).

In addition to processing downstream signals, the mFN 6 will also transmit Internet data traffic from the DOCSIS MAC 18 back to the head end. It also may be configured to perform transmission of upstream digital signals 12 and analog signals 13. These upstream signals 13 may be from and to existing legacy non-DOCSIS equipment.

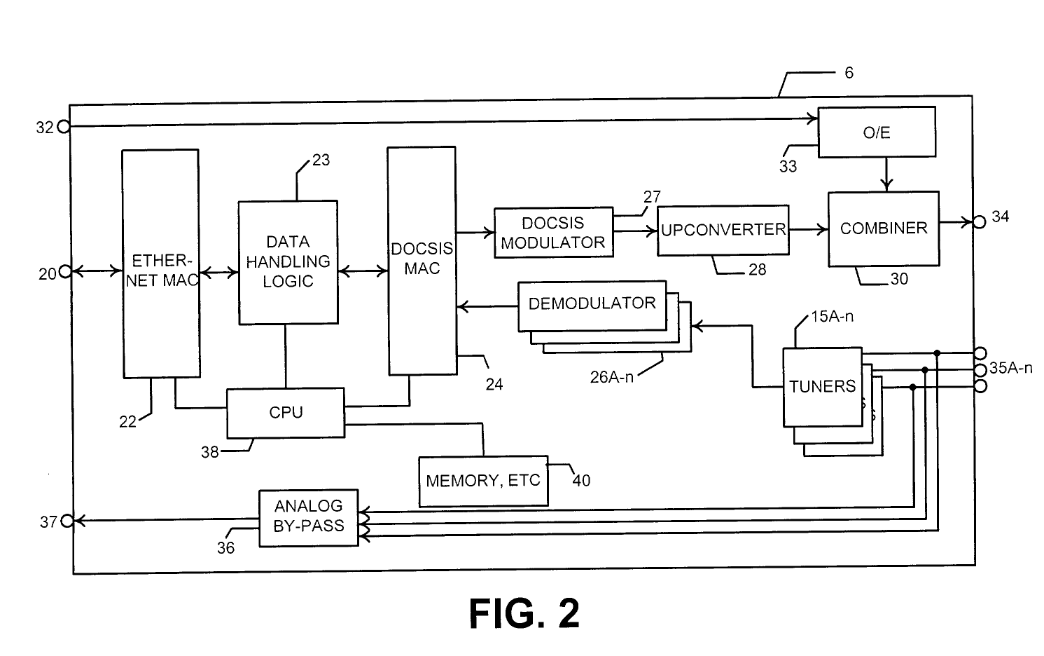

Turning now to FIG. 2, a block diagram of the internal components of an mFN used in a conventional dCMTS is shown. For purposes of example, the fiber network is assumed to use Ethernet technology, but other networking technologies may be used as well. A downstream digital message is received by mFN 6 at port 20 and is then routed through Ethernet MAC 22 and data-handling logic 23. Transit DOCSIS data passes to DOCSIS MAC 24 and then to DOCSIS modulator 27, which encodes the signal for transmission on the typically coaxial network using, for example, QAM modulation. Upconverter 28 changes the frequency of the signal output from DOCSIS modulator 27 for placement into the CATV channel plan. Combiner 30 combines this signal with the analog video stream from port 32 for transmission to a plurality of subscribers from port 34, the analog video stream having been converted from an optical to an electrical signal by optical-to-electrical converter 33.

Subscriber upstream ports 35A-n receive upstream signals from subscribers' network interface units. The DOCSIS portion of the signal is forwarded through tuners 15A-n to DOCSIS demodulators 26A-n and then to DOCSIS MAC 24. DOCSIS MAC 24 converts these signals to data packets, for example, and forwards them through data-handling logic 23 to ethernet MAC 22. These upstream DOCSIS signals are output from port 20 for transmission to the head end or to another mFN 6. Alternatively, in the case of signaling traffic, the signals are sent to CPU 38, which uses the information from the signals to direct traffic of other signals. The non-DOCSIS portion of the signal arriving at 35A-n is forwarded through analog bypass 36 to port 37. Port 37 may represent, for example, a separate fiber or a separate wavelength on the fiber. To operate and control the various functions of the Ethernet MAC 22 and the DOCSIS MAC 24, CPU 38, associated memory and other processor-related components 40 are typically contained in the mFN 6.

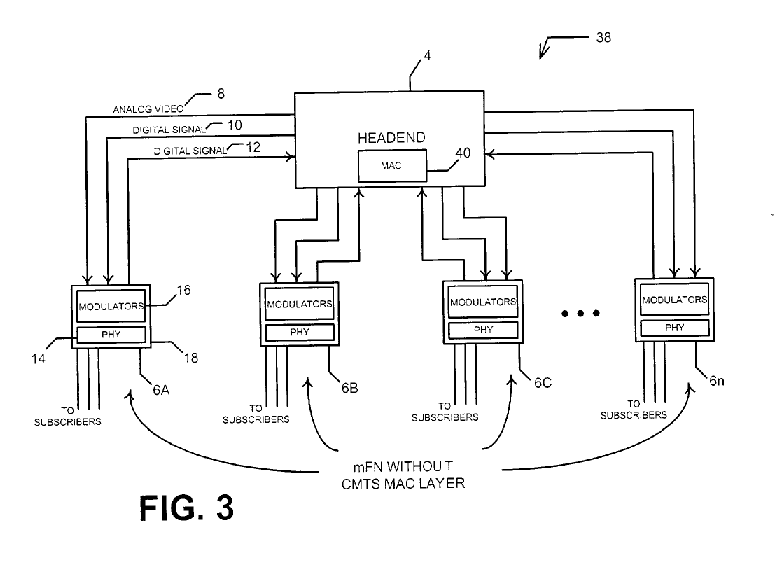

Turning now to FIG. 3, a topological schematic is illustrated of the fiber portion 38 of an HFC network using modified dCMTS technology, wherein MAC components 40 are centrally located at the head end 4 rather than remotely at individual mFN 6 as in a conventional dCMTS arrangement. However, the PHY layer components 14 and modulators 16 remain remotely located at the mFN 6 as in a conventional dCMTS. In addition, upconverters also remain remotely located at the mFN 6.

Thus, the bandwidth potential of transporting digital signals over the fiber portion 38 of an HFC network may be realized while using smaller mFNs 6 that house fewer components with respect to the mFNs shown in FIGS. 1 and 2. Thus, the arrangement shown in FIG. 3 facilitates video-on-demand, as well as other forms of narrowcast or unicast video, while at the same time using a physically smaller node size than is used in conventional dCMTS systems. This network architecture also features a digital upstream return path that facilitates transmission of signals from non-DOCSIS legacy equipment.

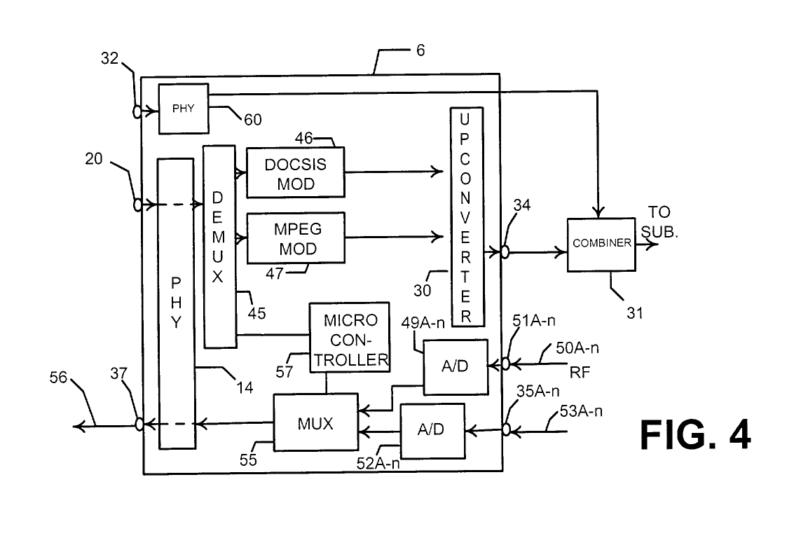

Turning now to FIG. 4, a block diagram of internal components of an mFN 6 used in a modified dCMTS with remote modulators is shown. As compared with system depicted by the block diagram of FIG. 2, a modified dCMTS system, which may also be referred to as a hybrid dCMTS system, having remote modulators, removes the Ethernet MAC 22 and the DOCSIS MAC 24 (shown in FIG. 2 but not in FIG. 4) from the mFN 6 and places them in the head end. As these MAC components and the CPU that operates them are typically some of the physically largest circuitry components contained in the mFN 6, removing them to the head end allows implementation with fewer components in the mFN. Thus, a smaller mFN 6 can be used.

FIG. 4 shows that an analog downstream signal received at port 32 is treated similarly as in the mFN shown in FIG. 2. However, since the MAC layer components are located at the head end in the modified dCMTS system, the digital signal received at port 20 feeds through PHY 14 and into demultiplexer 45. Since the MAC layer functions have already been performed at the head end, the MAC layer components are not used at the mFN 6. Accordingly, the circuitry footprint in the modified dCMTS mFN 6 is reduced.

Although the placement of the MAC layer components at the head end facilitates a smaller circuitry footprint at mFN 6, some additional components are introduced vis-a-vis a system that has MAC layer components at the mFN. Since additional heat-handling capacity, power, and space is available due to the removal of the MAC layer components to the head end, the footprint of mFN 6 illustrated in FIG. 4 may also include narrowcast video modulation components. For example, a digital MPEG signal is multiplexed with the DOCSIS data arriving at port 20. Demultiplexor 45, using, for example, time-division-multiplexing, separates this narrowcast MPEG video stream from the DOCSIS data stream. This stream is presented to MPEG modulator 47, which delivers the modulated signal to upconverter 30. Upconverter 30 inserts the MPEG video stream into the appropriate place in the CATV channel plan before being combined by combiner 31 for routing to a subscriber's SPE.

For the upstream direction, legacy A/D converter 49 converts analog upstream signals received from subscriber uplink 50 at legacy port 51 into digital signals. DOCSIS A/D converter 52 converts signals received from subscriber DOCSIS uplinlk 53 at port 35. Multiplexer 55 combines upstream digital signals from A/D converters 49 and 52 for transmission from port 37 to the head end 4. The types of A/D converters 49 and 52 may include parallel (flash), successive approximation, voltage-to-frequency and/or integrating converters, all known in the art. Bit density of the digitized signal may be fixed, but the frequency band of the analog signal being digitized may be software- or hardware-configurable, either locally or remotely with respect to the mFN 6.

It will be appreciated that analog upstream data and DOCSIS upstream data may be digitized by a single A/D converter. For each subscriber uplink port (there may be only one per subscriber rather than separate ports for analog and digital), the frequency band may be digitized without regard to whether DOCSIS and/or legacy signals are being carried upstream. The resulting upstream bit stream may be duplicated by a splitter at the head end and fed to DOCSIS demodulation components and legacy D/A components. The demodulation components, as well as components on the analog side of the D/A components at the head end, may have a predetermined preferred-frequency-band-of-interest from which to extract data from the wideband stream. For example, the frequency band 5 MHz-42 MHz may be digitized at the mFN. A particular DOCSIS demodulator at the head end may be configured to operate with data in the 36 MHz-39 MHz range and a circuit-switched-voice-device may be configured to operate with data in the 7 MHz-9 MHz range.

Accordingly, upstream fiber link 56 is used for upstream transmission from port 37 to the head end and the splitting of the upstream signals into analog and digital components occurs at the head end rather than at the mFN 6, as in the case of a conventional system as illustrated in FIGS. 1 and 2.

It will be appreciated that a plurality of links 50 and 53, ports 51 and 35, and converters 49 and 52 are used for A-n subscribers. However, only single components are represented in the diagram for clarity. Moreover, a single A/D converter may suffice for both DOCSIS and legacy upstream signals, depending on digitization quality needed, frequency width needed, and cost of the A/D component(s).

Uplink fiber infrastructure provides more bandwidth capacity to facilitate upstream legacy support. While an uplink fiber capable of one Gbps or higher may incur higher cost than may be associated with a conventional upstream link that, for example, accommodates 100-400 Mbps, if legacy upstream support is desired, a fiber supporting the higher bandwidth is preferable, since the upstream signal sent from the mFN 6 to the head end 4 is digital. The high bandwidth potential of fiber can be more advantageously used to provide higher upstream transfer rates than with a conventional dCMTS that also transmits a separate digitized analog signal in the upstream signal.

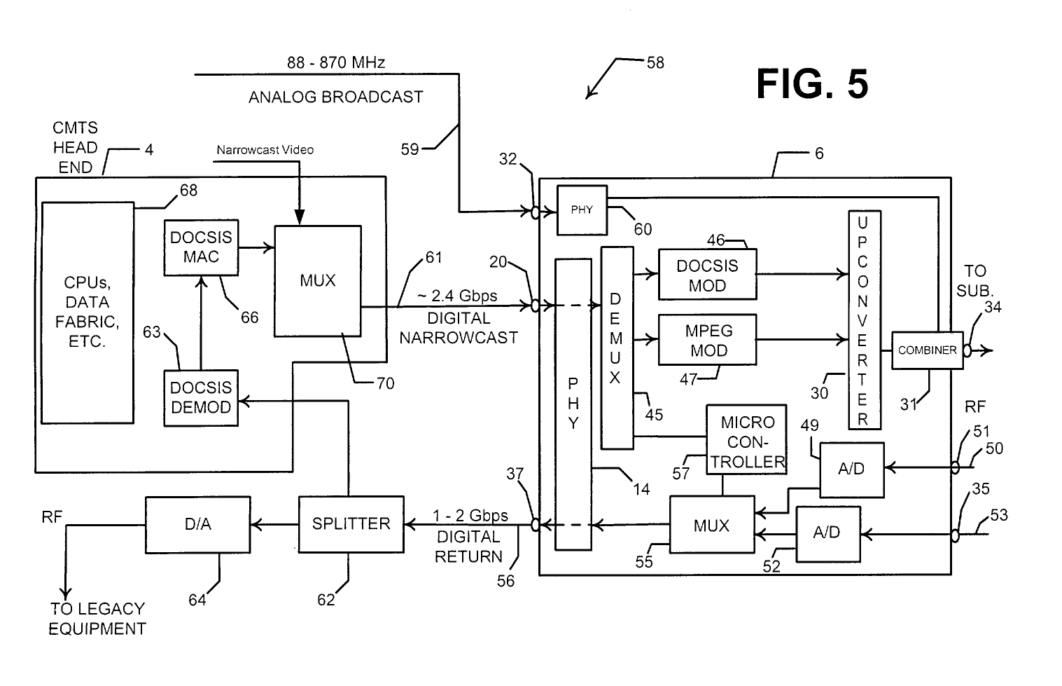

Turning now to FIG. 5, a schematic diagram of the preferable network topology for implementing a hybrid dCMTS system 58 with remote modulators is shown. The mFN 6 of FIG. 4 is shown coupled to head end 4. Port 32 of mFN 6 receives analog broadcast signals on downstream link 59. Downlink 59 may be either existing coax or fiber for providing CATV programming. The signal received at port 32 is fed through PHY 60, which may include an optical-to-electrical converter for handling the incoming downstream analog broadcast signal.

Mini fiber node 6 receives a digital signal, which may include both DOCSIS and narrowcast programming, at port 20 from digital downlink 61. After being processed through the PHY 14, which may include an optical to electrical converter for signals received at port 20, the digital signal is fed to demultiplexer 45 for processing and segregating bit streams of data. The segregated signals are fed into DOCSIS modulator 46 and MPEG modulator 47, each isolating DOCSIS data signals and MPEG video information, respectively, and then modulating each onto a different frequency, the DOCSIS information signal being carried on one frequency and the MPEG video information signal being carried on another. Modulators 46 and 47 provide the functionality that may be provided by modulators 27 and 28 of conventional dCMTS system architecture as illustrated in FIG. 2. Modulators illustrated in FIG. 5 are preferably QAM modulators, but may use other modulation techniques known in the art.

From the modulators, the DOCSIS signal and the MPEG signal are fed into upconverter 30. Upconverter 30 combines the digital signals from the DOCSIS Modulator 46 and MPEG Modulator 47, and changes the frequency of the combined signal to fit within the CATV channel plan for delivery of the signal to port 34 and combining with the analog broadcast signal at combiner 31.

The description of FIG. 5 has heretofore primarily related to the downstream functionality of the mFN 6. With respect to upstream traffic, transport of legacy system data, as well as DOCSIS data, is supported. DOCSIS upstream traffic from subscriber equipment is transported on subscriber side uplink 53, which is coupled to mFN 6 at port 35. The signal is fed to A/D converter 52 and then sent to multiplexer 55. Components of PHY 14 receive the output of multiplexer 55 and provide a multiplexed signal at upstream port 37. Additional signals from subscriber uplinks 50 are received at port 51 and fed through A/D 49 for processing. These additional signals may be combined by multiplexer 55 before transmission on uplink 56. These additional signals may represent different pools of subscribers or services with different modulation requirements, for example legacy services, as opposed to DOCSIS services.

A micro controller 57 controls the operation of modulators 46 and 47, and multiplexer 50. It will be appreciated that a PLL clock generator, driven by demultiplexer 45 and working in concert with micro controller 57, provides timing signals for modulators 46 and 47, as well as A/D converters 49 and 52. For clarity, the clock generator is not shown.

Still referring to FIG. 5, an aspect provides a unique solution for transmitting upstream DOCSIS and legacy traffic to the head end. In a conventional dCMTS system, the mFN typically communicates with the head end using Ethernet data packets. This reduces upstream bandwidth requirements by hundreds of Mbps over a traditional PON system. However, facilitating upstream legacy traffic, as well as DOCSIS data traffic, poses some difficulty. One solution may be to provide a separate link for transmitting legacy traffic. However, this typically requires pulling extra cable. Furthermore, more cable typically means more equipment to keep maintained and increases the likelihood of outages.

Digitizing the legacy traffic at mFN 6 of a hybrid dCMTS system 58, as illustrated in FIG. 5, allows combining said legacy traffic with DOCSIS upstream traffic on one uplink 56. This increases the bandwidth requirement of the uplink as compared with a conventional dCMTS system. But, since some DOCSIS and Quality of Service processing is still performed at the head end in a conventional system, development time of a hybrid system is reduced as compared with the development time necessary for implementation of a conventional dCMTS system. Moreover, if a conventional dCMTS system is designed to transmit legacy traffic over a single uplink, much of the bandwidth usage reduction with respect to a hybrid system is negated. Thus, to facilitate high bandwidth in the uplink, uplink 56 is selected so that greater than 1 Gbps (typically 1-2.5 Gbps) is supported.

The uplink signal is received at splitter 62, which duplicates the signal and delivers it to both the DOCSIS demodulator 63 and a digital-to-analog converter 64 for legacy signals.

After the DOCSIS signal is demodulated by demodulator 63, the DOCSIS signal is sent to DOCSIS MAC layer components 66. These DOCSIS components comprise the components that are located at the head end 4 rather than at the mFN 6, which would be the case in a conventional dCMTS system. The DOCSIS MAC layer components 66 in conjunction with head end CPU 68 determine where the signal goes next. If the signal is intended for another subscriber that is serviced off of the same mFN 6 that sent the upstream signal, then multiplexer 70 processes the signal and sends it as a downstream signal along link 61 to port 20 of the mFN. The signal is processed as described above with respect to mFN 6 and the intended subscriber receives the signal from port 34. If the intended subscriber is not served by the same mFN 6, the DOCSIS MAC components 66 direct the traffic to another mFN in network portion 58 or to another head end of a another network portion.

In addition to the hybrid dCMTS system 58 using a smaller mFN 6 than a conventional dCMTS system, the hybrid system may be cheaper for reasons other than using centralized CMTS components. For example, rather than having a separate power supply at each mFN 6, the mFNs in hybrid system 58 can share a single power supply located at the central head end 4. Power for components at the mFN 6 may be supplied via the analog downstream link 59, for example, as typical CATV systems provide power to SPE, such as network interface units. Thus, separate power supplies at each mFN 6 in a network are not required, thereby reducing network implementation costs. For example, a single 80-watt power supply at the head end 4 will typically cost less than individual 10-watt power supplies at eight mFNs 6. It will be appreciated that the head end 4 is illustrated in the figure without showing the power supply for clarity.

What is claimed is:

1. A distributed CMTS digital transmission system comprising:
a central head end having media access control layer components; and
means for modulating a plurality of signals intended for a plurality of subscribers, said modulating means remotely located from said central head end in each of a plurality of mini fiber nodes (“mFN”), said central head end and said mFNs being conmnunicatively coupled.

2. The system of claim 1 wherein the media access control layer components include the Data Over Cable System Interface Standard.

3. The system of claim 1 wherein the modulating means use quadrature amplitude modulation.

4. The system of claim 1 wherein the each mFN includes a first downstream port for receiving downstream analog signals, a second downstream port for receiving digital downstream signals and a digital upstream port for transmitting digital upstream signals.

5. The system of claim 4 wherein each mFN includes an analog downstream link communicatively coupled to the first downstream port, a digital downstream link communicatively coupled to the second downstream port and a digital upstream link communicatively coupled to the upstream port, the links communicatively coupling the mFN to the head end.

6. The system of claim 5 wherein the analog downstream link is a coaxial cable configured for transmitting signals in the range between and including 88 and 870 MHz.

7. The system of claim 5 wherein the downstream analog signal includes CATV broadcast programming.

8. The system of claim 5 wherein the analog downstream link is a fiber.

9. The system of claim 5 wherein the digital downstream link is a fiber for transmitting a digital downstream signal at a rate up to and including 2.4 Gbps.

10. The system of claim 4 wherein the digital downstream signals include digital narrowcast programming.

11. The system of claim 10 wherein the digital narrowcast programming includes video programming.

12. The system of claim 11 wherein the digital video program is MPEG-formatted program data.

13. The system of claim 4 wherein the digital downstream signals include DOCSIS-formatted data.

14. The system of claim 5 wherein the digital upstream link is a fiber for transmitting digital data at up to and including 2 Gbps.

15. The system of claim 5 wherein the digital upstream link is a fiber configured for transmitting optical signals at a rate above 2 Gbps.

16. The system of claim 5 wherein each mFN includes a plurality of first analog-to-digital converter means for transforming DOCSIS radio-frequency signals to corresponding digital signals for upstream transmission.

17. The system of claim 16 wherein the plurality of digital signals are digitally multiplexed to form a single digital signal for upstream transmission.

18. The system of claim 16 wherein each mFN includes a plurality of second analog-to-digital converters for transforming legacy analog radio-frequency signals to digital signals for upstream transmission.

19. The system of claim 18, wherein each mFN includes an upstream multiplexer for combining the plurality of signals output from at least one first A/D converter and at least one second A/D converter into a multiplexed digital signal for upstream transmission.

20. The system of claim 18 wherein the legacy signals are used to control CATV set-top boxes.

21. The system of claim 18 wherein the legacy signals are used for circuit-switched telephony-over-cable.

22. The system of claim 18 wherein the legacy signal is a non-DOCSIS cable modem communications channel.

23. The system of claim 5 further comprising a plurality of analog-to-digital converters in each of the plurality of mFNs for transforming a plurality of disparate analog service signals into digital signals for upstream multiplexing.

24. The system of claim 23 wherein the disparate analog signals have different digitization requirements.

25. The system of claim 23 wherein the service signals contain information of type selected from the group including DOCSIS data, set-top-box control information and circuit-switched telephony information.

26. The system of claim 19 further comprising a plurality of splitters corresponding to the digital upstream links, wherein the head end includes a DOCSIS demodulator for demodulating upstream legacy signals received from the splitters.

27. The system of claim 19 further comprising a downstream multiplexer for receiving data from the media access control layer components and for transmitting the data to a backbone network, a CPU or one of the plurality of mFNs.

28. The system of claim 1 further comprising a power supply for powering the components at the head end, wherein power from said power supply is also transmitted from the head end via a downstream link to one of the plurality of mFNs.

29. A mini fiber node comprising means for modulating a plurality of signals intended for a plurality of subscribers within a distributed CMTS digital transmission system, the distributed CMTS system comprising a central head end having media access control layer components.

30. The mFN of claim 29 wherein the media access control layer components include the Data Over Cable System Interface Standard.

31. The mFN of claim 29 wherein the modulating means uses quadrature amplitude modulation.

32. The mFN of claim 29 further comprising a first downstream port for receiving at least one downstream analog signal, a second downstream port for receiving at least one digital downstream signal and a digital upstream port for transmitting at least one digital upstream signal.

33. The mFN of claim 32 wherein the at least one downstream analog signal includes CATV broadcast programming.

34. The mFN of claim 32 wherein the at least one digital downstream optical signal includes digital narrowcast programming.

35. The mFN of claim 34 wherein the digital narrowcast programming includes video programming.

36. The mFN of claim 35 wherein the digital video program is MPEG-formatted program data.

37. The mFN of claim 32 wherein the digital downstream signal includes DOCSIS-formatted data.

38. The mFN of claim 29 further comprising a plurality of first analog-to-digital converter means for transforming DOCSIS radio-frequency signals received from a plurality of subscribers to a corresponding plurality of corresponding digital signals for transmission to the head end.

39. The mFN of claim 38 wherein the plurality of digital signals is digitally multiplexed to form a single digital signal for upstream transmission to the head end.

40. The mFN of claim 38 further comprising a plurality of second analog-to-digital converters for transforming legacy analog radio-frequency signals received from a plurality of subscribers to digital signals for upstream transmission to the head end.

41. The mFN of claim 40 further comprising an upstream multiplexer for combining the plurality of signals output from the first A/D converters and the second A/D converters into a multiplexed digital signal for transmission to the head end.

42. The mFN of claim 41 wherein the legacy signals are used to control CATV set-top boxes.

43. The mFN of claim 41 wherein the legacy signals are used for circuit-switched telephony-over-cable.

44. The mFN of claim 41 wherein the legacy signal is a DOCSIS communications channel.

45. The mFN of claim 29 further comprising a plurality of analog-to-digital converters for transforming a plurality of disparate analog service signals into digital signals before upstream multiplexing.

46. The mFN of claim 45 wherein the disparate analog signals have different digitization requirements.

47. The mFN of claim 45 wherein the service signals contain information of type selected from the group including DOCSIS data, set-top-box control information and circuit-switched telephony information.

48. A head end of a distributed CMTS digital transmission system, the system having a plurality of mFNs with means for modulating a plurality of signals intended for a plurality of subscribers, the head end comprising media access control components.

49. The head end of claim 48 wherein the media access control components perform control of DOCSIS data.

50. The head end of claim 48 further comprising a multiplexing means for routing upstream signals received from one of the plurality of mFNs to another mFN.

51. The head end of claim 48 further comprising DOCSIS demodulation means for demodulating upstream DOCSIS data separated from upstream legacy data sent from an mFN.

52. A method for operating a distributed CMTS system comprising:
performing media access control layer functions at a head end; and
performing, remotely from the head end, modulation functions at a mFN.

53. The method of claim 52 further comprising performing analog to digital conversion of upstream DOCSIS data at the mFN.

54. The method of claim 53 further comprising performing analog to digital conversion of upstream legacy data at the mFN.

55. The method of claim 54 further comprising multiplexing the DOCSIS data and the legacy data and sending upstream on a single link.

56. The method of claim 55 further comprising:
separating the upstream DOCSIS data from the upstream legacy data;
routing the legacy data to legacy equipment; and
routing the separated DOCSIS data to a DOCSIS demodulator at the head end.

57. The method of claim 52 further comprising performing analog to digital conversion of upstream data at an upstream subscriber port regardless of whether the upstream data is DOCSIS data or legacy data.

58. The method of claim 57 further comprising feeding the digitized upstream data to a DOCSIS demodulator and at least one of a plurality of legacy digital-to-analog converters.

59. The method of claim 52 further comprising impressing subscriber data into an upstream link using time-division-multiplexing wherein at least one of a plurality of upstream subscriber ports at the mFN serves a plurality of subscribers.

60. The method of claim 59 further comprising performing analog to digital conversion of upstream data at an upstream subscriber port regardless of whether the upstream data is DOCSIS data or legacy data.

61. The method of claim 60 further comprising feeding the digitized upstream data to a DOCSIS demodulator and at least one of a plurality of legacy digital-to-analog converters.
